(19) United States
(12) Patent Application Publication
(10) Pub. No.: US 2007/0016475 A1
(43) Pub. Date: Jan. 18, 2007

(54) METHOD AND DEVICE FOR INTERACTIVE COLLECTION OF CUSTOMER INFORMATION

(76) Inventor: Jarret Calmenson, New York, NY (US)

Correspondence Address: WILLIAM COLLARD;COLLARD & ROE, P.C., 1077 NORTHERN BOULEVARD, ROSLYN, NY, 11576, US

(21) Appl. No.: 11/308,000

(22) Filed: Mar. 2, 2006

Related U.S. Application Data
(60) Provisional application No. 60/657,768, filed on Mar. 2, 2005.

(51) Int. Cl. G06Q 30/00

(52) U.S. Cl. 705/14

(57) ABSTRACT

A device and a process for tracking customer information in a remote location. The device can include a kiosk which can include a touch screen, a fold down, or fold up sign, a PCMCIA card reception element, a stand, and a base. This type of kiosk can be in wired or wireless communication with a remote computer or server. There can also be a process which may use the above device having one or more of the above stated features. The process can include a plurality of different optional steps including but not limited to providing an interactive kiosk; presenting a plurality of questions on the interactive kiosk to a user, these questions can be used to as one of a plurality of methods to steps to identify the user. Next, another optional step can include tracking purchases of that user. This step can include tracking the purchases of the user at a point of purchase location such as a cash register, an interactive kiosk used for scanning and purchasing items, or any online purchases by that user for a particular store housing the kiosk. In another optional step, least one set of promotional information of a product can be presented to the user based upon either a purchase of that user or based upon answers to said questions from that user.

### CROSS REFERENCE TO RELATED APPLICATIONS

This application is a non-provisional application and hereby claims priority from U.S. patent application Ser. No. 60/657,768 titled “METHOD AND DEVICE FOR INTERACTIVE COLLECTION OF CUSTOMER INFORMATION” to Jarret Calmenson, which was filed on Mar. 2, 2005 and the disclosure of which is hereby incorporated herein by reference.

### BACKGROUND

The invention relates to a method and device for interactive collection of customer information. For example, there is a device that can be in the form of a touch screen kiosk placed in a particular location in a store, or in a restaurant. This device would receive information from a user, by asking that user a series of questions. Once this information has been received it can be communicated wirelessly to a remote location for processing of this information. For example the following U.S. patents include disclosures generally relating to this field: U.S. Pat. Nos. 6,381,744; 6,619,545; 6,674,428; 6,691,915; 6,901,374; 6,954,732; 6,976,032; 5,708,782; 5,949,411; 6,262,717; 6,289,326; 6,349,257; and 6,415,555; the disclosures of which are hereby incorporated herein by reference.

### SUMMARY

The invention relates to a device and a process for tracking customer information in a remote location. The device can include a kiosk which can include a touch screen which can be in the form of a LCD screen, a fold down, or fold up sign, a PCMCIA card reception element, a stand, and a base. This type of kiosk can be in wired or wireless communication with a remote computer or server.

There can also be a process which may use the above device having one or more of the above stated features. The process can include a plurality of different optional steps including but not limited to providing an interactive kiosk; presenting a plurality of questions on the interactive kiosk to a user, wherein these questions can be used as one of a plurality of methods or steps to identify the user. Next, another optional step can include tracking purchases of that user. This step can include tracking the purchases of the user at a point of purchase location such as a cash register, an interactive kiosk used for scanning and purchasing items, or any online purchases by that user for a particular store housing the kiosk. In another optional step, least one set of promotional information of a product can be presented to the user based upon either a purchase of that user or based upon answers to said questions from that user.

The step of identifying can include asking a question of a user including the name of the user. The user can also be identified by receiving information from the user's identifying element, this user's identifying element can be in the form of a credit card, an RFID tag on a user, or a purchasing card for a user.

This process can also include a step which includes identifying products presented in a region adjacent to the interactive kiosk. This process can include identifying all products within a particular radius or region adjacent to the interactive kiosk. Next, the process can include identifying a product that is closest to the kiosk, wherein the kiosk can then present information on the closest product. Alternatively, the user can scroll through the remaining objects to select information on other identified products for review of further information. This kiosk could also present these products in a particular order based upon different criteria such as price, size, or any other identifying information.

The presentation of this promotional information can include the presentation of a coupon on a video screen, which can then be downloaded to an electronic storage item held by the user such as a purchase plan card, or stored in a database for presentation to the user upon purchasing. Alternatively, the presentation can include printing a coupon for that user.

This step of presenting at least one set of promotional information can also include presenting a location of a product in a store housing the product.

This system can also tailor the information being presented based upon modifying the promotional information based upon characteristics of a particular user. This step can also include modifying the presentation of the promotional information based upon previous purchases of that user based upon that user's answers to previous questions, or based upon that user's personal characteristics.

The user's personal characteristics can includes characteristics selected from the group consisting of: birth date; family member's birth date; and an anniversary of enrollment in a purchasing plan. Other optional characteristics can include, age, sex, married status etc.

This device can be used for the enrollment or registration of a customer loyalty card, a rewards card, or a gift card/coupon card upon joining a buying program. In this case, the user can receive an instant reward or an incentive coupon, which is printed at a kiosk or receive an electronic coupon via email, which can be automatically sent to a customer or member.

There can also be a system wherein a customer/user or member can redeem points at a kiosk for money saving coupons rewards.

In this case the system can also include a database and a system wherein a user can gift their points to another member or to use these points in a network or system wherein a user could then use these points attained in one store, and then transfer these points towards rewards in another participating store or company.

Ultimately, this device and process can create an automated and interactive shopping experience for a particular user in a store.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a perspective view of a customer enrollment kiosk;

FIG. 2 is an exploded perspective view of the device shown in FIG. 1;

FIG. 3 is a close up view of a presentation section of a kiosk;

FIG. 4 is a flow chart for the process for using the kiosk;

FIG. 5 is a first screen shot on the screen of the kiosk;

FIG. 6 is a second screen shot on the screen of the kiosk;

FIG. 7 is a third screen shot on the screen of the kiosk;

FIG. 8 is a fourth screen shot on the screen of the kiosk;

FIG. 9 is a perspective view of another embodiment of the kiosk;

FIG. 10 is a schematic block diagram of the electronics layout in the kiosk;

FIG. 11 is a block diagram of the network including the kiosk; and

FIG. 12 is a table format showing the outline of a database for sharing information between an enrolled user and other enrolled users and enrolled stores.

### DETAILED DESCRIPTION

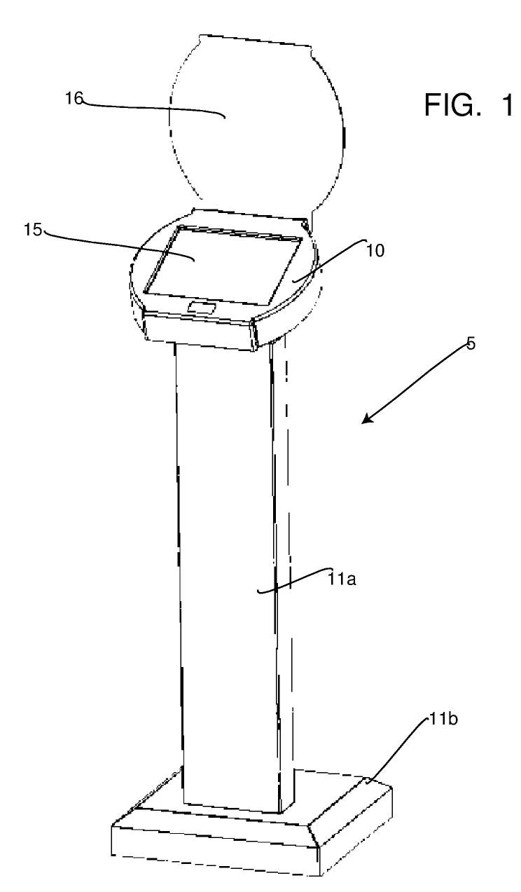

FIG. 1 is a perspective view of a customer enrollment kiosk 1. This device can include a presentation section 10 which is coupled to a stand 11a, wherein that stand is coupled to a base 11b. Presentation section 10 can include a touch screen 15, which can be in the form of a LCD screen. There can also be a cover 16 which is coupled to presentation section 10. Cover 16 can be used to cover touch screen 15 when touch screen 15 is not in use. However, when cover 16 is turned up, it can be used in the form of a sign, either disposed on an inside surface or an outside surface of cover 16.

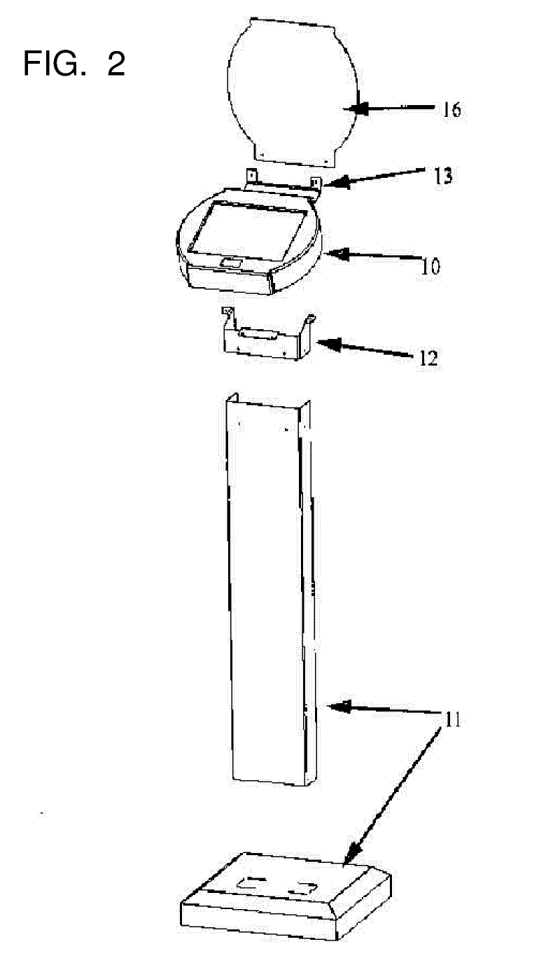

FIG. 2 shows an exploded view of this device 1. In this view, there is a bracket 12 which can be coupled to stand 11a, wherein bracket 12 can be used to couple presentation section 10 to stand 11a. In addition, there is a bracket 13, wherein bracket 13 can be used to couple cover 16 to presentation section 10. Bracket 13 can include a hinge to allow cover 16 to be rotated up and away from touch screen 15 or down on top of touch screen 15.

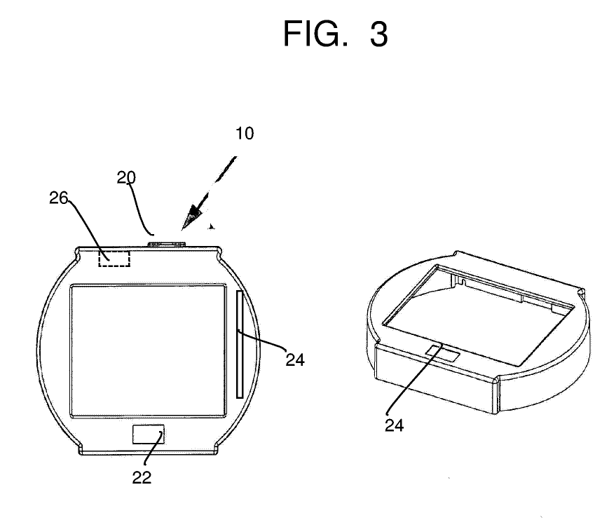

FIG. 3 shows presentation section 10 including at least one information receiving device. These information receiving devices can include a PCMCIA slot 20, a credit, debit or other identification card magnetic strip slot 24, a scanner 22, or an RFID transceiver 26.

The PCMCIA slot can be used to insert and remove a PCMCIA card that may be used for any known purpose. For example, this type card that may contain a substantial amount of software for an installation or upgrade. The credit, debit, or other identification card magnetic strip 24 is optional and can be used to receive information from a magnetic strip of an identification card such as an enrollment card or purchase plan card associated with a particular store, a credit card or a debit card. Scanner 22 is an optional scanner that can be used to scan a bar code of a particular item to allow a user to have kiosk 1 further identify the product being presented. Once the magnetic strip has been scanned, information about that product can be uploaded to touchscreen 15 allowing a user to review this information in greater detail. RFID transceiver 26 can be used to communicate with an RFID card which may be attached to an item. In this case, if the item is within range of RFID transceiver 26, it can recognize the presence of this item and then scan it or pull this information up on screen 15 so that the user can further read about that item.

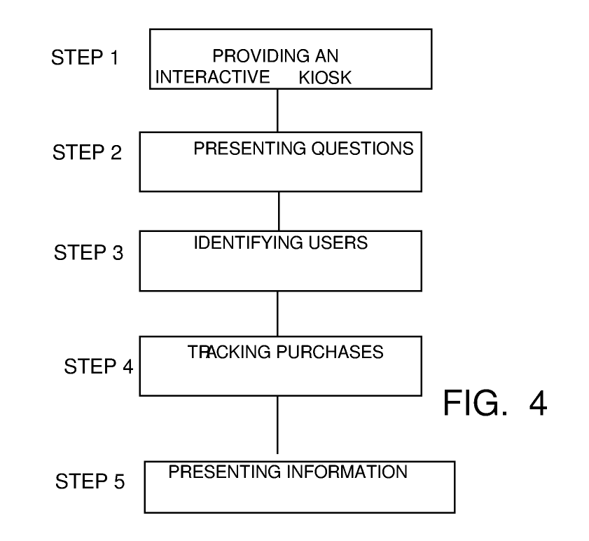

The device can be used to perform a series of steps. For example, FIG. 4 shows a flow chart for a process for enrolling, and identifying, users and/or items in a store. In this case, device 5 or some form of device 5 can be used to perform many of these steps.

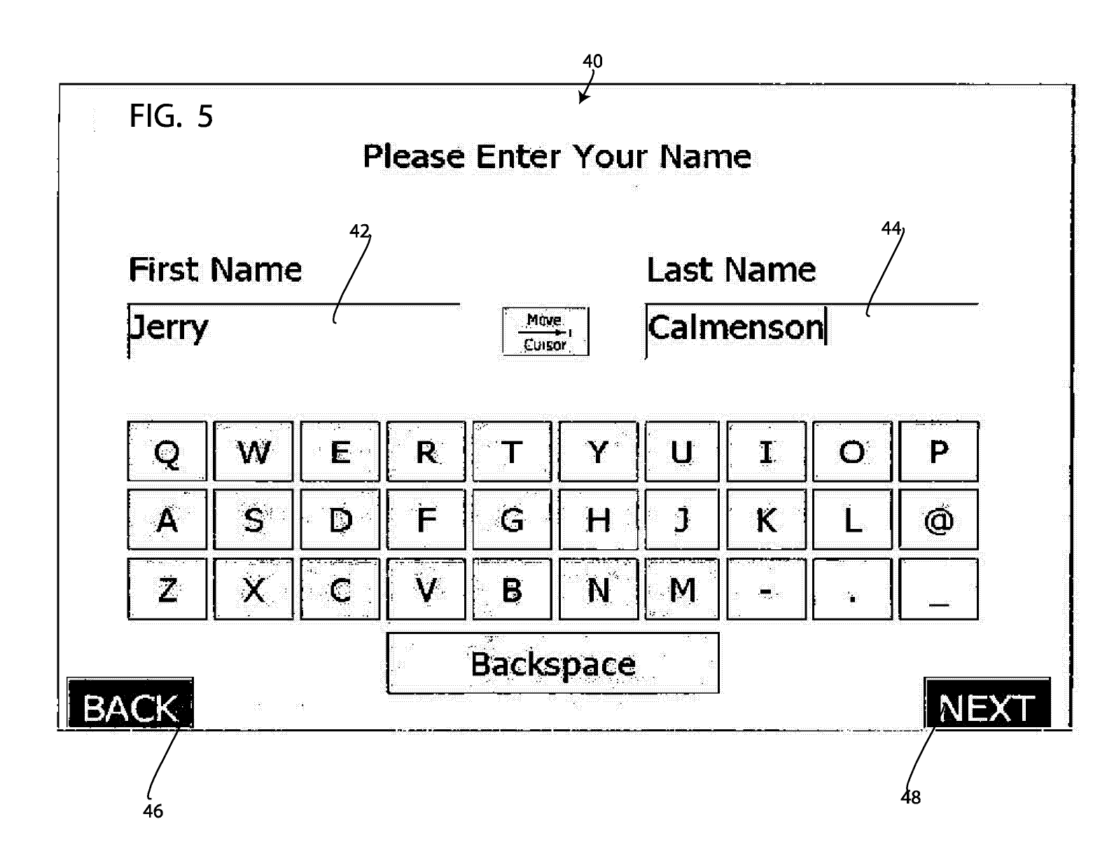

For example, step 1 includes providing an interactive kiosk, such as interactive kiosk 5 shown in FIG. 1. In step 2, a series of questions could be presented, wherein these questions could be in the form of a request to enter a user's name such as shown in FIG. 5. In this case there is a screen shot shown of a screen 40 which include a keyboard presented on a touchscreen, and two questions which can be in the form of a first name question 42, and a last name question 44. There are also navigation buttons 46 and 48 which can be used for back and next navigation respectively.

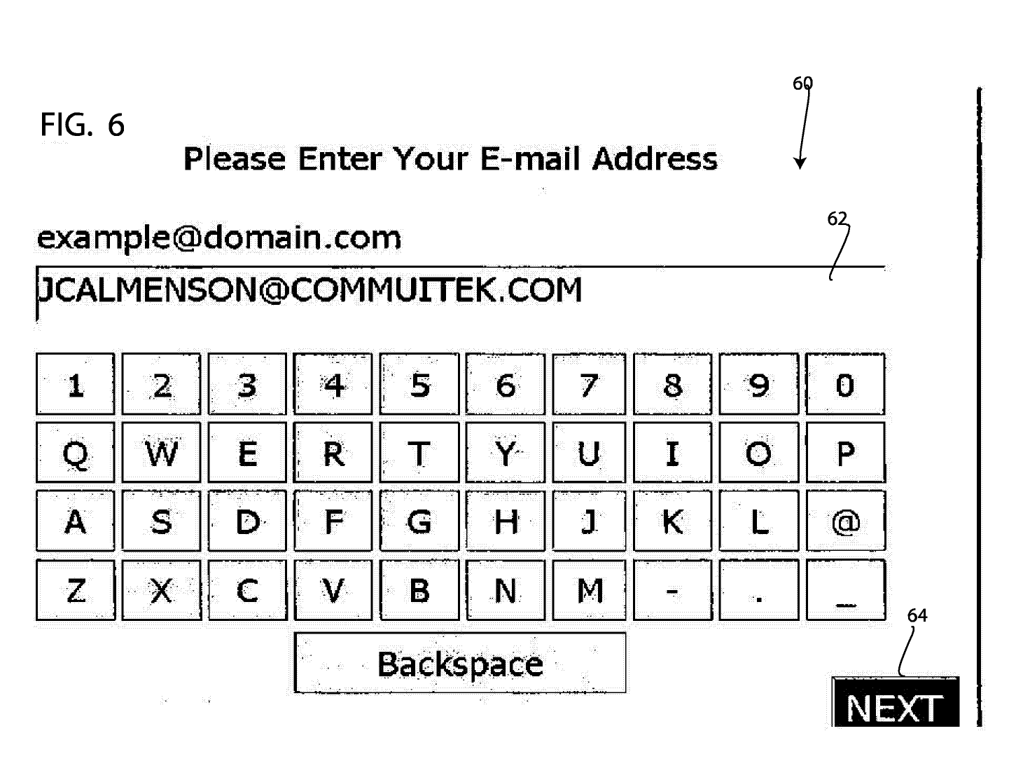

FIG. 6 shows another screen shot 60 which includes at least one question relating to a user's email address, 62, which can be typed in by a user on a keyboard. There is also a navigation button 64 which can be used to allow a user to move on to another screen.

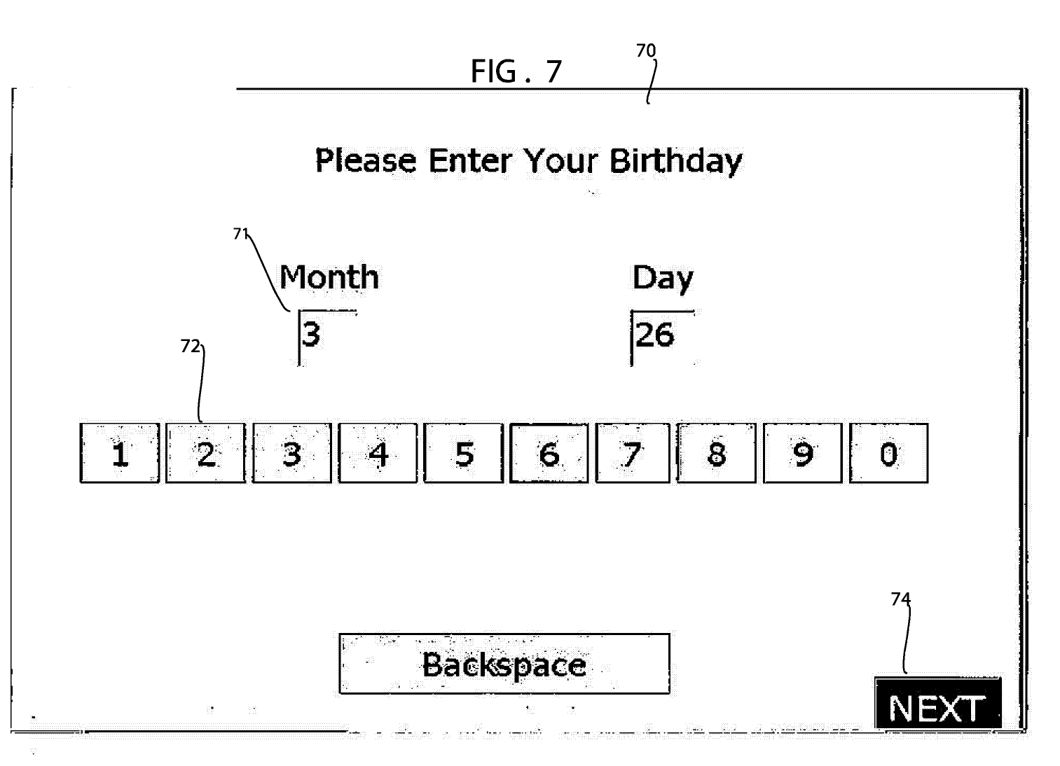

FIG. 7 is another screen shot 70 which includes a question about a user's birthday 71, along with a different type of keyboard 72 which essentially contains numbers. There is also at least one navigation button 74 disposed on this touch screen.

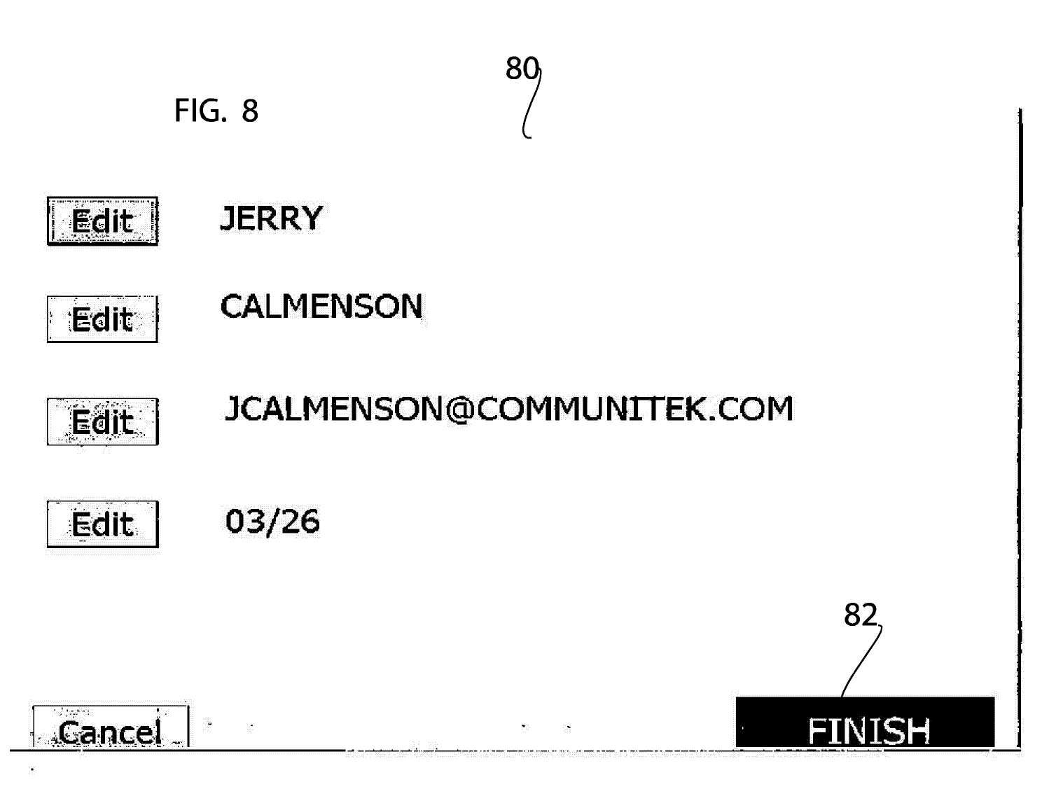

FIG. 8 is a final screen 80 which can be used to allow the user to verify his or her information. Once this information has been verified, the user can hit the finished button 82 so that the information can be communicated to a remote server either through a wired manner or wirelessly from kiosk 5 via a wireless transceiver.

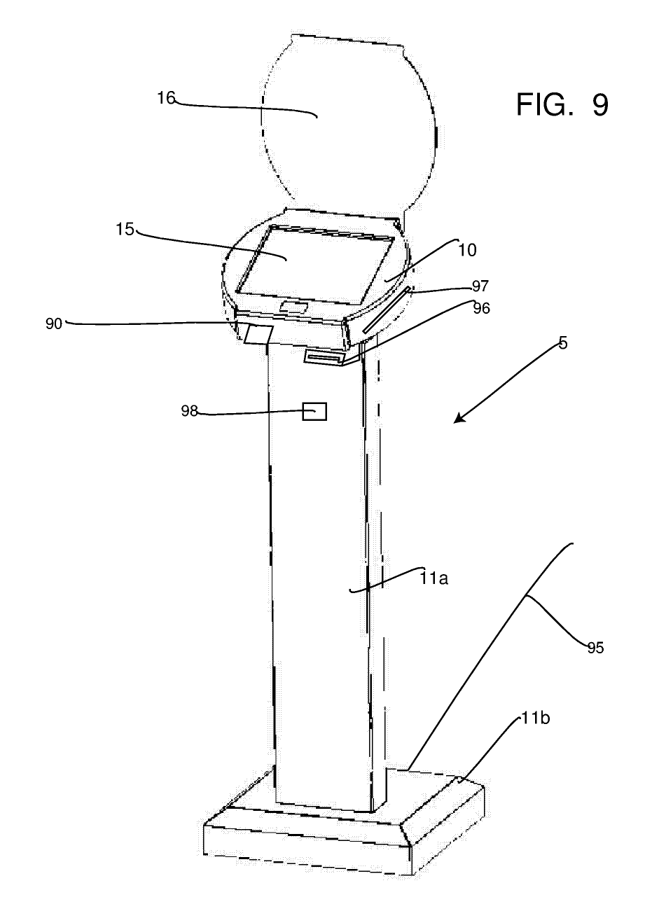

These types of questions can be used to enroll a user in a purchasing program or a to obtain a rewards card. Once this information has been completed, a participating store or company in the rewards program may print out a card at that location or it may mail a printed card to a participant at their home. In fact, this process can be the first step in identifying users such as shown in FIG. 3. Other ways to identify users can include tracking users based upon whether that user scans his or her card into magnetic strip 24, or into another card reader such as a card reader 96 shown in FIG. 9. The identity of a user can also be obtained via a RFID reading of a user on a card, using RFID reader 26. In this case, a user walking near a kiosk 5, could be identified by the kiosk by RFID reader 26 so that kiosk 5 could present tailored information to the user as the user gets close to RFID reader 26.

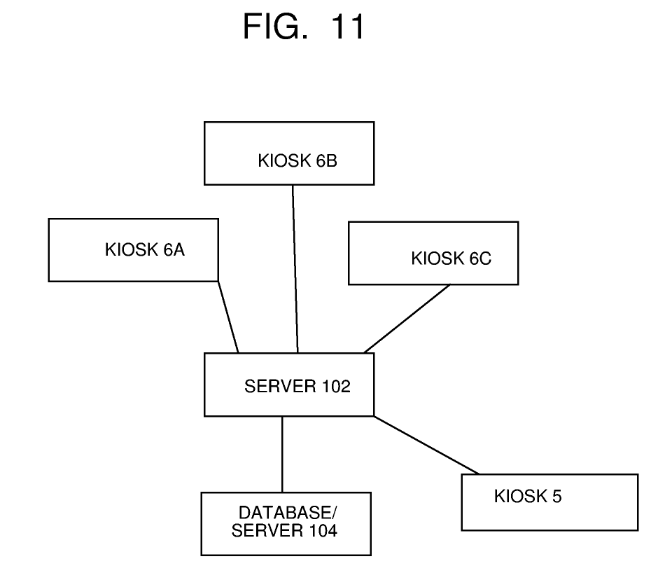

In step 5, the system can be used to track the purchases of particular users. For example, as a user purchases an item either through a point of purchase such as at a cash register or at one of these kiosks, the purchase is recorded in a database in a server (See FIG. 11). With this tracking system, the system can then identify this user when the user approaches a kiosk 5 and then present future purchase choices to the user.

Thus, in step 5, the system can present information to the user via LCD touch screen 15. This information can be other items located in the store, or for example coupons for future purchases for the user. These coupons can be presented either on the screen, wherein, the system will remember the identity of the user when that user purchases an item and present the coupon at purchase. Alternatively, kiosk 5 could print a coupon for a user (See FIG. 9 below). Third, a user could download this coupon information to its purchase plan card which can be inserted into a magnetic reader and recording slot 24 (See FIG. 3) or via a card reader 96 (See FIG. 9.)

The presentation of this information could be prompted by kiosk 5 reading the presence of a user adjacent to this kiosk, via an RFID tag on a purchase plan card, or by identifying products presented adjacent to kiosk 5. These products themselves could have an associated RFID tag disposed on the packaging to allow kiosk to identify the product. A third way could be using scanner 22, which could allow a user to scan his card or a product into scanner 22 using a bar code to allow the kiosk or system to read that particular product. Information on that product could appear on touch screen 15 or be printed out from printer 97.

FIG. 9 shows an alternative embodiment of the device shown in FIG. 1. In this embodiment, there is a wireless transceiver 90 disposed inside of kiosk 5. There can also be an alternative communications line 95 which may be used to communicate with a remote service. For example, both wireless transceiver 90 and communications line 95 can be used to communicate with a computer network to either send information or to receive information or to receive updates to a computer program being stored and run in kiosk 5. There is also a different type of card reader 96 which can be used to read an enrollment card when inserted into reader 96.

An optional printer 97 can be attached or disposed inside of kiosk 5 wherein this printer 97 can be used to print out any additional information to a user. This printer 97 could also be configured to directly print out an enrollment card after a user has enrolled in a purchasing program.

There is also an optional identity chip 98 stored in kiosk 5 which can be used to identify that particular kiosk.

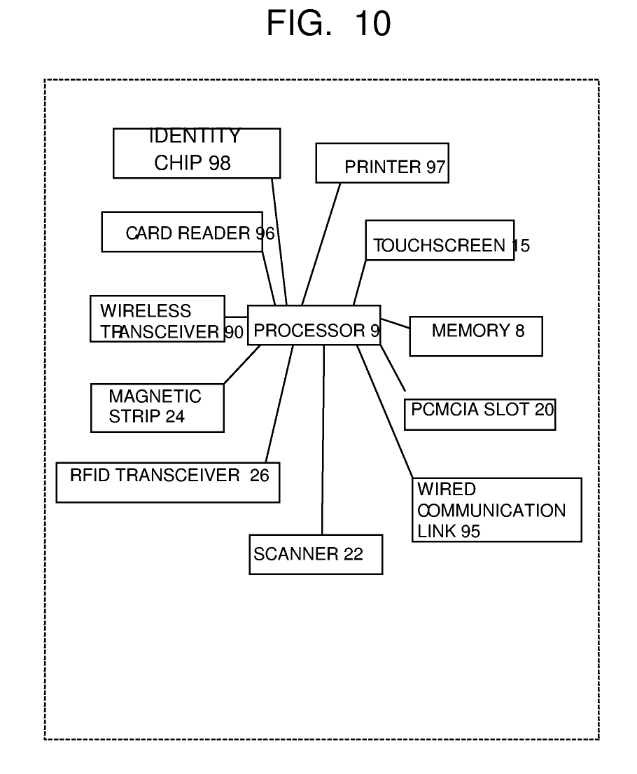

FIG. 10 shows a schematic block diagram for the electronic components of the kiosks shown in FIGS. 1 and 9. For example, there is processor 9 which can be disposed inside of a kiosk 5 or inside of a presentation section 10 wherein this processor 9 can be in communication with a memory device 8 which can be in the form of a ROM, RAM, or flash memory device for storing a program or a process for presenting information to a user. Other elements can also be in communication with processor 9 such as a touchscreen 15, a pcmcia slot 20, a scanner 22, a magnetic slot 24, a RFID transceiver 26, a wireless transceiver 90, a wired communication link 95, a card reader 96, printer 97 and identity chip 98.

Processor 9 receives instructions from information, or a computer program stored on memory 8. This processor 9 controls these components and it also either reads information sent from any one of the components or it sends instructions to these components.

FIG. 11 is a schematic block diagram of a computer network for communicating with a particular kiosk 5. In this embodiment, there is shown at least one remote kiosk 5 with optional additional kiosks 6A, 6B, and 6C being in communication with a computer network 100. Computer network 100 can include a plurality of servers, but can include at least one server 102, which can store a database 104 and which can be used to enroll a user in a buying rewards program and to forward information about that user, or about products in a store to that particular kiosk 5. Server 102 tracks the identity and location of each kiosk via an associated identity chip 98.

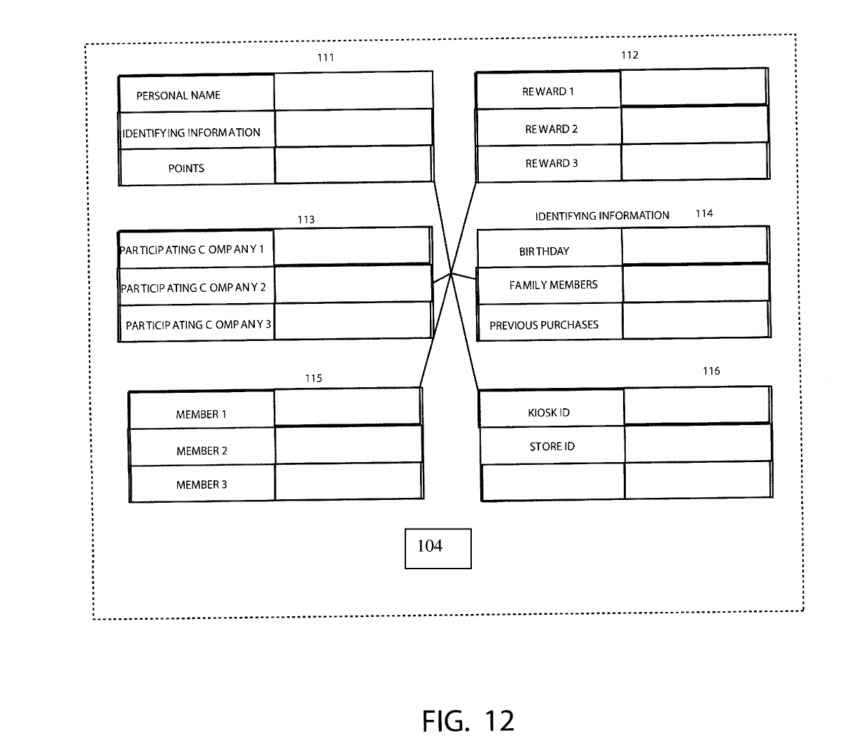

FIG. 12 is a table format showing the outline of a database 104 for sharing information between an enrolled user and other enrolled users and enrolled stores. For example, there is a first table 111 which can be used to receive information on particular users. This information can include the user's name, the identifying information, including birthday, family members, previous purchases and also an identifying ID, all stored in an associated table 114. Between tables 111 and 114, these tables can be used to store all information on all enrolled users.

There is a table 112 which can include a listing of possible rewards. These rewards can include different rewards based upon different levels of points. The different rewards can be allocated in different stores. Table 113 can include information on participating companies which include stores or participating point of purchase locations which may participate in this buying program. For example, the participating companies can include stores, restaurants, or any other places of commerce where a user can redeem his points.

Table 115 can include a listing of all of the participating members, wherein one member can gift his or her points to another participating member. For example, a user can gift all or a portion of his or her points to a family or friend who is participating in this purchasing program. This process can include having the kiosk prompt a user to gift points to another user listed as a friend or family member in the user's identifying information in table 114. This type of prompt can occur when the system determines that this family member or friend has a birthday. Next, the user can select to give these points over to the participating member. Once this gift has been given, the kiosk through printer 97 can print out a receipt for the user.

This database can also include a database table 116 which can be used to identify each kiosk and the location of each kiosk. In this way, a central server can track the activity on each of the kiosks distributed throughout a network. With this design, depending on the identifying information in the kiosk, a central server can distribute and control the information being displayed on each kiosk including the presentation of particular rewards in participating stores.

For example, a user can enroll in a loyalty card/rewards program by entering in his or her name, identifying information, including his or her birthday, family members, friends, and interests in purchases. Points based upon purchases in participating stores will then be attributed to this user. The kiosk 6 can then print via printer 97 a gift reward card for rewards related to the amount of previous purchases. Next, once the user has enrolled, kiosk 6 could print via printer 97 a coupon based upon a plurality of rewards shown in tables 102. Alternatively, or in addition, the system could email or wirelessly send an electronic coupon which could be printed out at a remote location, or stored with that user in server 102, wherein that user can redeem this electronic coupon when producing and scanning his or her rewards card at the final point of purchase. At any time during this process, the user can gift his or her points to another participating member, or request particular rewards at particular participating stores.

Accordingly, while at least one embodiment of the present invention has been shown and described, it is to be understood that many changes and modifications may be made thereunto without departing from the spirit and scope of the invention as defined in the appended claims.

What is claimed is:

1. A process for tracking customer information in a remote location comprising the following steps:
a) providing an interactive kiosk;
b) presenting a plurality of questions on said interactive kiosk to a user;
c) identifying said user;
c) tracking purchases of said user; and
d) presenting at least one set of promotional information of a product to said user based upon either a purchase of said user or based upon answers to said plurality of questions from said user.

2. The process as in claim 1, wherein said step of presenting a kiosk includes presenting a kiosk having a touch screen.

3. The process as in claim 1, wherein said kiosk is in communication with a remote server.

4. The process as in claim 3, wherein said kiosk is in wireless communication with a remote server.

5. The process as in claim 1, wherein said step of identifying said user includes asking a question of a user including the name of the user.

6. The process as in claim 1, wherein said step of identifying said user includes receiving information from said user's identifying element.

7. The process as in claim 6, wherein said step of identifying said user includes reading said user's identifying element in the form of a credit card.

8. The process as in claim 6, wherein said step of identifying said user includes reading an RFID tag on a user.

9. The process as in claim 1, further comprising identifying products presented in a region adjacent to said interactive kiosk.

10. The process as in claim 9, wherein said step of identifying products presented in a region adjacent to said interactive kiosk comprises:
a) identifying all products within a particular radius or region adjacent to said interactive kiosk;
b) identifying a closest product taken from all identified products and then presenting information on said closest product; and
c) allowing said user to select other identified products for review of further information.

11. The process as in claim 1, wherein said step of presenting at least one set of promotional information includes presenting a coupon for said user.

12. The process as in claim 11, wherein said step of presenting at least one set of promotional information includes printing a coupon for said user.

13. The process as in claim 1, wherein said step of presenting at least one set of promotional information includes presenting a location of a product in a store housing the product.

14. The process as in claim 13, wherein said step of presenting said promotional information further comprises the step of modifying said promotional information based upon characteristics of a particular user.

15. The process as in claim 14, wherein said step of modifying promotional information includes selecting particular promotional information based upon previous purchases of a user.

16. The process as in claim 14, wherein said step of modifying promotional information includes selecting particular promotional information based upon said user's answers to previous questions.

17. The process as in claim 14, wherein said step of modifying promotional information includes selecting particular promotional information to present to said user based upon said user's personal characteristics.

18. The process as in claim 17, wherein said user's personal characteristics includes characteristics selected from the group consisting of: birth date; family member's birth date; and an anniversary of enrollment in a purchasing plan.
